(19) United States
(12) Patent Application Publication
(10) Pub. No.: US 2025/0330544 A1
(43) Pub. Date: Oct. 23, 2025

(54) IMAGE READING DEVICE, RECORDING DEVICE, FLEXIBLE FLAT CABLE, METHOD FOR MANUFACTURING FLEXIBLE FLAT CABLE, AND METHOD FOR MANUFACTURING IMAGE READING DEVICE

(71) Applicant: SEIKO EPSON CORPORATION, Tokyo (JP)

(72) Inventor: Toshimitsu OHARA, MATSUMOTO-SHI (JP)

(21) Appl. No.: 19/180,920

(22) Filed: Apr. 16, 2025

(30) Foreign Application Priority Data
Apr. 19, 2024 (JP) 2024-068168

(51) Int. Cl. H04N 1/00

(52) U.S. Cl. CPC H04N 1/0083; H04N 1/00816; H04N 2201/0094

(57) ABSTRACT

An image reading device includes: an image reading unit that moves in a scanning direction and thus reads a document; a control unit that controls the image reading unit; and a cable that electrically couples the image reading unit and the control unit to each other, the cable including a curved portion and being folded so that a folded ridge faces outward at the curved portion, in a fold region folded along a longitudinal direction, the image reading unit and the control unit not being electrically coupled in the fold region.

The present application is based on, and claims priority from JP Application Serial Number 2024-068168, filed Apr. 19, 2024, the disclosure of which is hereby incorporated by reference herein in its entirety.

### BACKGROUND

### 1. Technical Field

The present disclosure relates to an image reading device, a recording device, a flexible flat cable, a method for manufacturing a flexible flat cable, and a method for manufacturing an image reading device.

### 2. Related Art

JP-A-2020-150508 discloses a configuration of an image reading device in which a sensor unit that reads a document and a sensor control unit are coupled via a flexible flat cable (FFC), which is flexible. The FFC is bent in a direction in which the sensor unit moves.

JP-A-2020-150508 is an example of the related art.

However, in the method described in JP-A-2020-150508, the FFC may come into contact with the document table glass or the like due to the movement of the sensor unit, and when the frictional force due to the contact increases, the FFC may be caught or the reading result may be affected by an operation failure of the sensor unit.

### SUMMARY

According to an aspect of the present disclosure, an image reading device includes: an image reading unit that moves in a scanning direction and thus reads a document; a control unit that controls the image reading unit; and a flexible flat cable that electrically couples the image reading unit and the control unit to each other, the flexible flat cable including a curved portion and being folded so that a folded ridge faces outward at the curved portion, in a fold region folded along a longitudinal direction, the image reading unit and the control unit not being electrically coupled in the fold region.

According to another aspect of the present disclosure, a recording device includes: the image reading device described above; and a recording unit that records an image read by the image reading device on a medium.

According to still another aspect of the present disclosure, a flexible flat cable electrically coupling an image reading unit that moves in a scanning direction and thus reads a document and a control unit that controls the image reading unit is provided, the flexible flat cable including a curved portion and being folded so that a folded ridge faces outward at the curved portion, in a fold region along a longitudinal direction, the image reading unit and the control unit not being electrically coupled in the fold region.

According to still another aspect of the present disclosure, a method for manufacturing a flexible flat cable electrically coupling an image reading unit that moves in a scanning direction and thus reads a document and a control unit that controls the image reading unit is provided, the method including: folding the flexible flat cable so that a folded ridge faces outward at a curved portion, in a fold region along a longitudinal direction; and causing the image reading unit and the control unit not to be electrically coupled in the fold region.

According to still another aspect of the present disclosure, a method for manufacturing an image reading device is provided, the image reading device including an image reading unit that moves in a scanning direction and thus reads a document, a control unit that controls the image reading unit, and a flexible flat cable that electrically couples the image reading unit and the control unit to each other, the method including: folding the flexible flat cable so that a folded ridge faces outward at a curved portion, in a fold region along a longitudinal direction of the flexible flat cable; causing the image reading unit and the control unit not to be electrically coupled in the fold region; and coupling the flexible flat cable to the image reading unit and the control unit.

### BRIEF DESCRIPTION OF THE DRAWINGS

FIG. 1 is a perspective view showing the configuration of a recording device.

FIG. 2 is a perspective view showing the configuration of an image reading device.

FIG. 3 is a perspective view showing the configuration of a housing.

FIG. 4 is a plan view showing the configuration of the housing.

FIG. 5 is a plan view showing the internal configuration of the housing.

FIG. 6 is a perspective view showing the internal configuration of the housing.

FIG. 7 is a cross-sectional view taken along a cross section V-V of the housing shown in FIG. 4.

FIG. 8 is a perspective view showing the internal configuration of the housing.

FIG. 9 is a cross-sectional view of the housing shown in FIG. 8.

FIG. 10 is a perspective view showing the configuration of an image reading unit and a cable.

FIG. 11 is a perspective view showing the configuration of the cable.

FIG. 12A is an enlarged plan view showing a part D of the cable shown in FIG. 11.

FIG. 12B is a cross-sectional view taken along a line E-E of the cable shown in FIG. 12A.

FIG. 13 is a plan view showing the configuration of the low-friction member attached to a document table.

### DESCRIPTION OF EMBODIMENTS

The configurations of a scanner 1 as an image reading device and a recording device 100 will now be described with reference to the drawings. In the drawings described below, three axes orthogonal to one another will be described as an X axis, a Y axis, and a Z axis. A direction along the X axis is defined as an “X direction”, a direction along the Y axis is defined as a “Y direction”, a direction along the Z axis is defined as a “Z direction”, a direction of an arrow is defined as a +direction, and a direction opposite to the +direction is defined as a −direction. A view from the +Z direction or the −Z direction is also referred to as a plan view or planar.

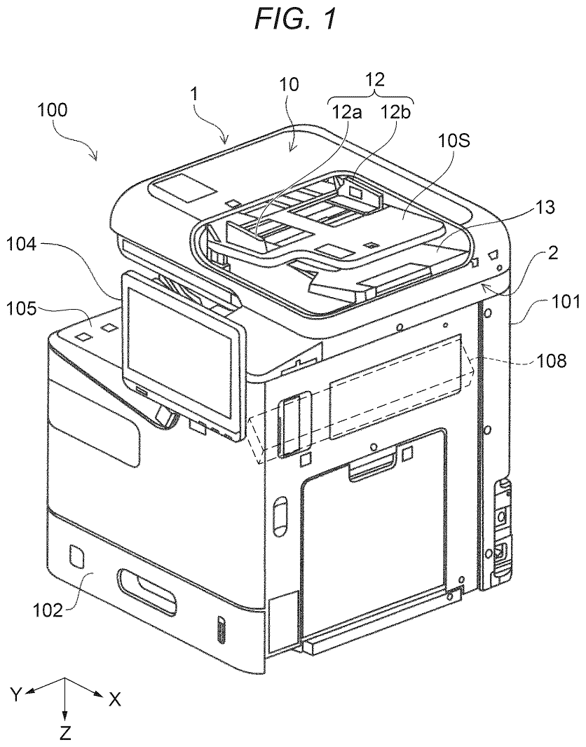

First, the configuration of the recording device 100 will be described with reference to FIG. 1.

The recording device 100 is, for example, an inkjet printer that ejects ink onto a medium. The recording device 100 includes a recording unit 101 as a recording unit and the scanner 1 disposed above the recording unit 101. The recording device 100 is, for example, a multifunction peripheral.

The scanner 1 has the function of an automatic document feeder (ADF). The scanner 1 includes a document table opening/closing part 10, a document setting part 10S, a guide part 12, and a discharge tray 13. When the scanner 1 is in a posture in which the document table opening/closing part 10 is opened, the scanner 1 is accessible by the user and a document can be placed on a document table 4, described later.

The guide part 12 guides a document placed on the document setting part 10S. The guide part 12 includes a first edge guide 12a and a second edge guide 12b. The first edge guide 12a is supported so as to be slidable in the direction along the Y axis. The second edge guide 12b is supported so as to be slidable in the direction along the Y axis.

For example, a document read by the scanner 1 is placed on the discharge tray 13. Specifically, for example, a document read by an image reading unit 6, described later, is placed on the discharge tray 13.

The recording unit 101 has a recording function of recording an image on a medium. The recording unit 101 includes a paper feed unit 102, an operation unit 104, a paper discharge unit 105, and a recording head 108.

The paper feed unit 102 accommodates a medium. The paper feed unit 102 in the present embodiment is one paper feed cassette. The paper feed unit 102 may include a plurality of paper feed cassettes. When the paper feed unit 102 includes a plurality of paper feed cassettes, the paper feed cassettes accommodate media of the same size or different sizes. The medium accommodated in the paper feed unit 102 is transported to a position facing the recording head 108 by a transport unit, not illustrated.

The operation unit 104 is provided at a side surface of the recording device 100. The operation unit 104 is operated by a user. The user performs various operations on the operation unit 104. The operation unit 104 includes a display unit and a plurality of operation buttons. The display unit of the operation unit 104 may be configured with a display having a touch input function. In this case, the operation unit 104 may not include the operation buttons. The operation unit 104 may be provided to be able to be tilted in relation to the side surface of the recording device 100.

A medium discharged from the recording unit 101 is placed on the paper discharge unit 105. The paper discharge unit 105 is provided between the scanner 1 and the recording unit 101.

The recording head 108 records an image on a medium. The recording head 108 records an image on a medium, based on a document. The read data for recording an image on a medium includes data read by the image reading unit 6 of the scanner 1, described later. The recording head 108 is a line-type inkjet head that can eject a liquid to the entire medium in the Y-axis direction. The recording head 108 may be provided on a carriage and configured to be moved forward and backward along the X axis by the carriage.

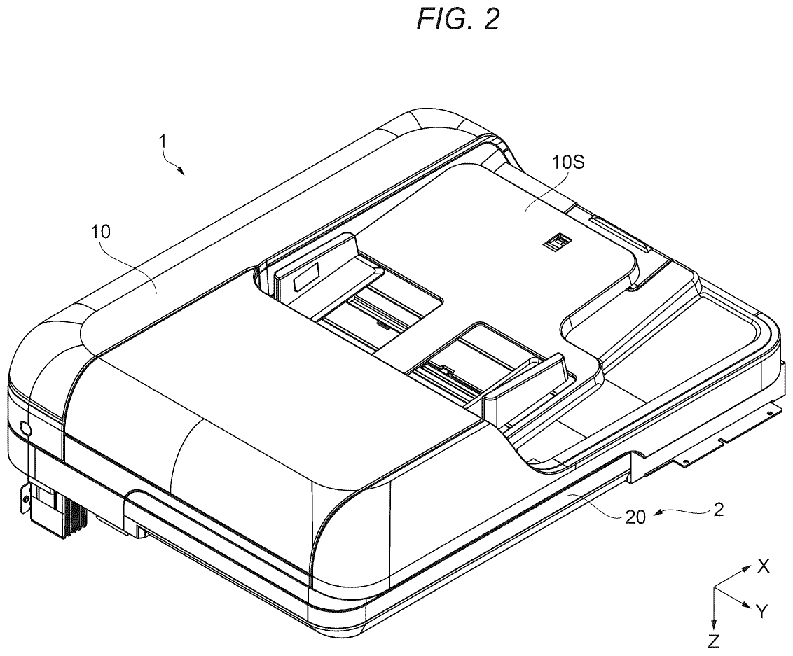

Next, the configuration of the scanner 1 will be described with reference to FIGS. 2 to 12B.

As shown in FIG. 2, the scanner 1 is a flatbed-type scanner. The scanner 1 includes a housing 2, the document table opening/closing part 10, and the document setting part 10S.

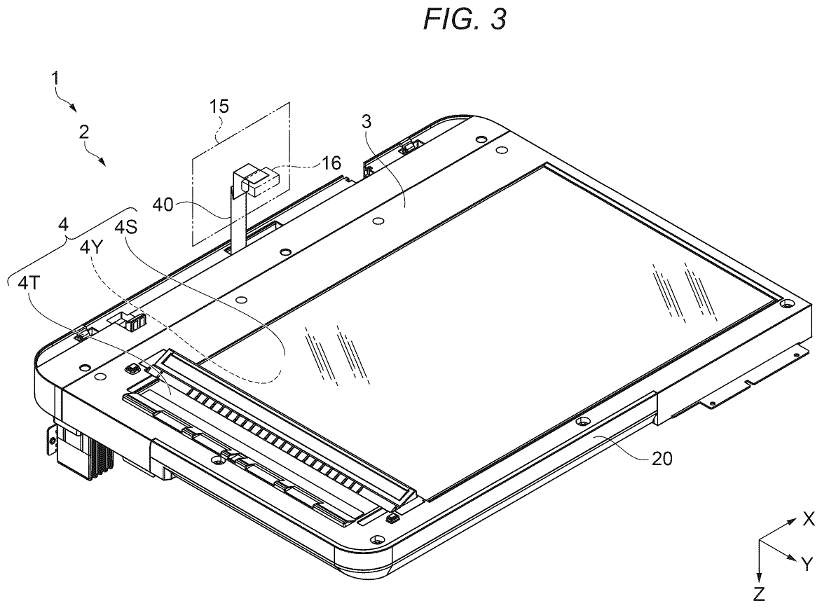

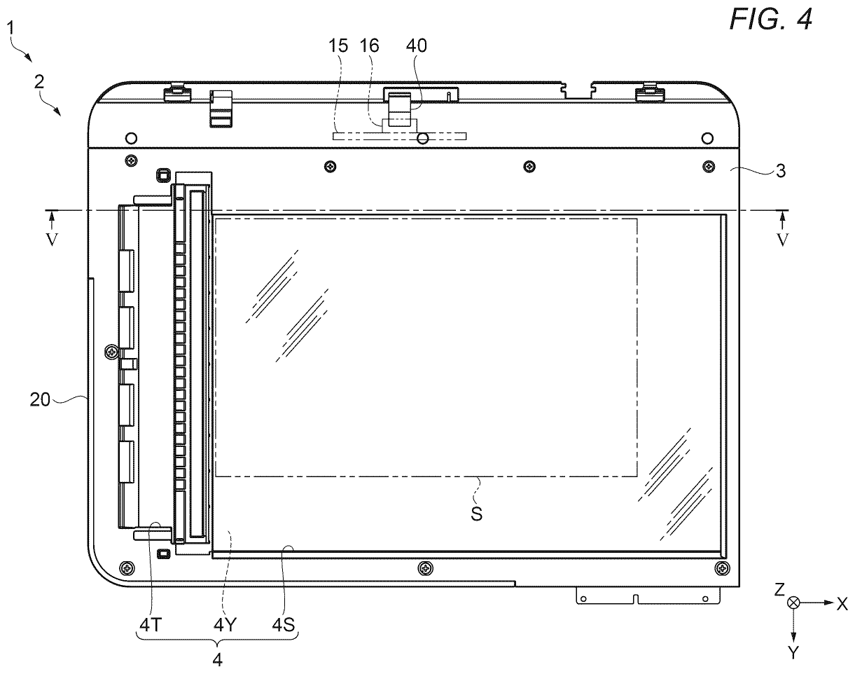

As shown in FIGS. 3 and 4, the housing 2 includes a frame 3, the document table 4, a case 20, and a cable 40 as a flexible flat cable. For the sake of description, a control unit 15 provided inside the document table opening/closing part 10 is indicated by a double-dotted dashed line in FIGS. 3 and 4.

The control unit 15 controls the image reading unit 6. The control unit 15 converts an output signal transmitted from the image reading unit 6 into read data. As described above, the control unit 15 is provided inside the document table opening/closing part 10, which is provided outside the housing 2. As illustrated in FIGS. 3 and 4, the control unit 15 is provided with a connector 16 indicated by a double-dotted dashed line.

The document table 4 is a transparent glass plate. The document table 4 includes a placement surface 4S on which a document S is placed, a transport surface 4T, and a reading surface 4Y. The transport surface 4T is located at the −X direction side of the placement surface 4S. The outer edges of the placement surface 4S and the transport surface 4T are formed by covering a part of the surface of the document table 4 on the −Z direction side with the frame 3. That is, the frame 3 defines the outer edges of the placement surface 4S and the transport surface 4T.

The reading surface 4Y is disposed at a surface of the document table 4 on the +Z direction side. The document table 4 has a closed state where the document table 4 is covered by the document table opening/closing part 10 rotatable in relation to the housing 2, and an open state where the document S can be placed.

As illustrated in FIGS. 3 to 6, the case 20 has a box shape that is open on the −Z direction side, and forms an inner bottom surface 2D and inner side surfaces 2F, 2B, 2R, and 2L of the housing 2. The inner bottom surface 2D defines the +Z direction side in the internal space of the housing 2. The inner side surface 2F defines the +Y direction side in the internal space of the housing 2. The inner side surface 2B defines the −Y direction side in the internal space of the housing 2. The inner side surface 2R defines the +X direction side in the internal space of the housing 2. The inner side surface 2L defines the −X direction side in the internal space of the housing 2. The document table 4 and the frame 3 are provided so as to cover the opening of the case 20 and thus form the internal space of the housing 2.

The document table opening/closing part 10 includes an automatic document reading mechanism. The scanner 1 has a mode in which the document S is placed on the placement surface 4S and the document S is read, and a mode in which the document S is set at the document setting part 10S of the document table opening/closing part 10 and the automatic document reading mechanism is activated to read the document S transported to the transport surface 4T.

A support part 21 that supports the cable 40 is provided at the inner bottom surface 2D of the case 20. The support part 21 faces the reading surface 4Y and extends in the X-axis direction along the reading surface 4Y. The support part 21 is provided at a position overlapping the frame 3 in the Y-axis direction.

The image reading unit 6 is provided inside the housing 2 so as to be able to read the document S placed at the placement surface 4S and the document S transported to the transport surface 4T. The image reading unit 6 is provided between the reading surface 4Y and the support part 21 in the Z-axis direction.

The image reading unit 6 includes a reading unit 7 and a carriage 8. The image reading unit 6 moves in the scanning direction, that is, the X direction and thus reads the document. The image reading unit 6 is provided in the internal space of the housing 2 so as to extend in the Y-axis direction.

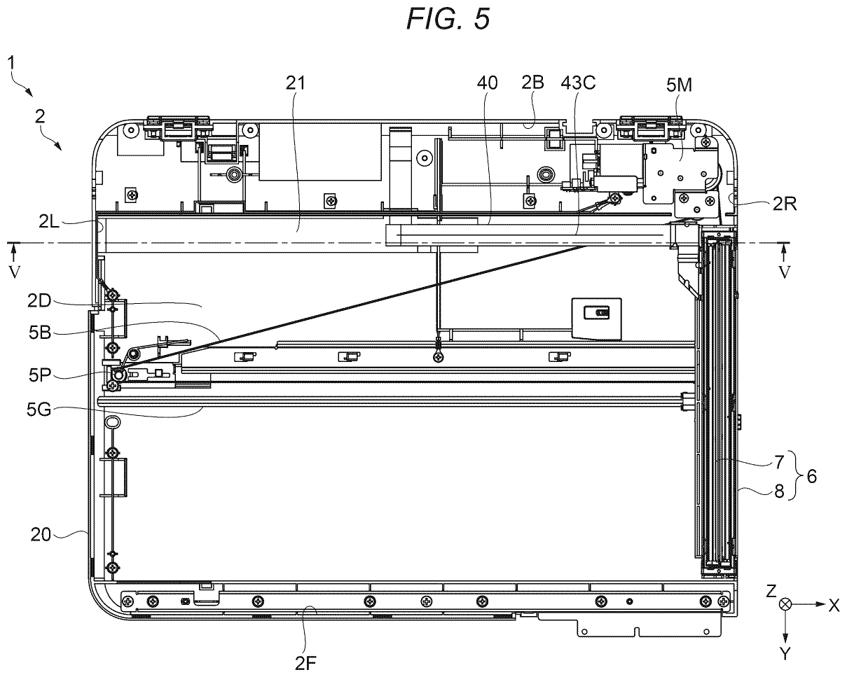

As illustrated in FIGS. 5 to 8, the carriage 8 is guided by a guide 5G provided at the inner bottom surface 2D of the case 20 and thus moves forward and backward in the X-axis direction. A transport belt 5B is fixed to the carriage 8. The transport belt 5B is wound between a pulley 5P and a belt driving unit 5M. As the belt driving unit 5M is driven, the carriage 8 is guided by the guide 5G and moves forward and backward in the X-axis direction.

As shown in FIGS. 3 and 4, the cable 40 electrically couples the image reading unit 6 and the control unit 15. The cable 40 is a thin plate-like wiring member having a plurality of core wires 50 and is a flexible flat cable. The core wire 50 is covered with an insulator such as a resin. The core wire 50 may be referred to as a wiring.

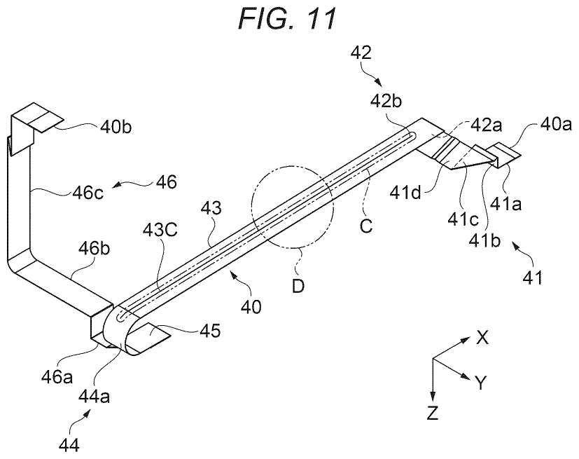

As illustrated in FIG. 11, terminal parts 40a and 40b represent one end and the other end of the cable 40. The core wire 50 at the terminal parts 40a and 40b has one surface covered with an insulator and the other surface exposed. The cable 40 is provided inside the housing 2 so that the plurality of core wires 50 are arranged next to each other in the Y-axis direction and so that the terminal part 40a side of the cable 40 extends in the X-axis direction.

The cable 40 includes a first wiring part 41, a second wiring part 42, a third wiring part 43, a fourth wiring part 44, a fifth wiring part 45, and a sixth wiring part 46. The second wiring part 42, the third wiring part 43, the fourth wiring part 44, and the fifth wiring part 45 extend along the X-axis direction.

The first wiring part 41 is a region coupling the terminal part 40a to the second wiring part 42. The first wiring part 41 includes a wiring 41a extending in the −X direction from the terminal part 40a, a wiring 41b extending in the −Z direction from the wiring 41a, a wiring 41c folded back from the wiring 41b, and a wiring 41d extending in the −Y direction from the wiring 41c.

The second wiring part 42 includes a wiring 42a and a wiring 42b that continue from the wiring 41d of the first wiring part 41 and are folded back.

The third wiring part 43 is a region whose length changes according to the position of the image reading unit 6 in the X-axis direction. For example, the length of the third wiring part 43 when the image reading unit 6 is located on the +X direction side of the center of the movable range in the X-axis direction is longer than the length of the third wiring part 43 when the image reading unit 6 is located at the center of the movable range.

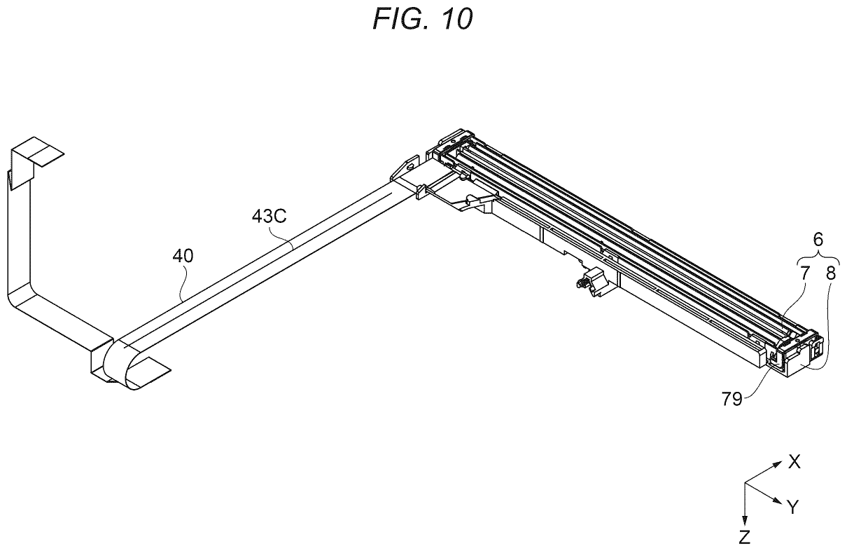

As illustrated in FIGS. 10 and 11, the third wiring part 43 in the cable 40 has a fold region C folded along the longitudinal direction. The fold region C is provided at a part of the third wiring part 43 facing the document table 4 by the movement of the image reading unit 6. The fold region C may include a range of fold tolerance in addition to the actually folded region.

As illustrated in FIG. 11, a mountain 43C is formed in the third wiring part 43 in the fold region C. The mountain 43C is folded so as to face outward at a curved portion 44a, described later. The mountain 43C faces the document table 4.

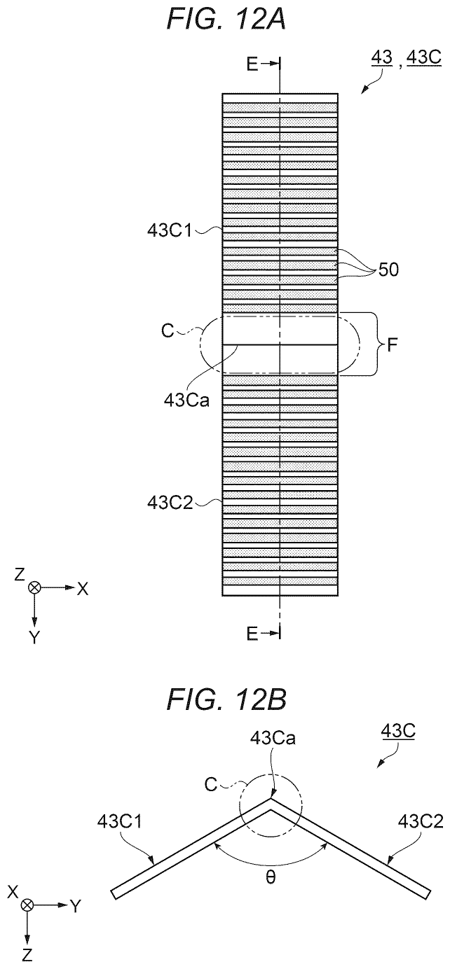

As shown in FIGS. 12A and 12B, the mountain 43C is formed by a first surface 43C1 of the third wiring part 43, a second surface 43C2 of the third wiring part 43, and a part where the first surface 43C1 and the second surface 43C2 are coupled together, that is, a top part 43Ca. The angle of the mountain 43C, that is, the fold angle θ between the first surface 43C1 and the second surface 43C2, is an obtuse angle. The fold angle θ is, for example, 120°.

The fourth wiring part 44 of the cable 40 has the curved portion 44a whose direction of extension changes toward the −X direction. In other words, the curved portion 44a is curved along a plane intersecting the document table 4. In the present embodiment, the curved portion 44a is curved along the XZ plane intersecting the document table 4.

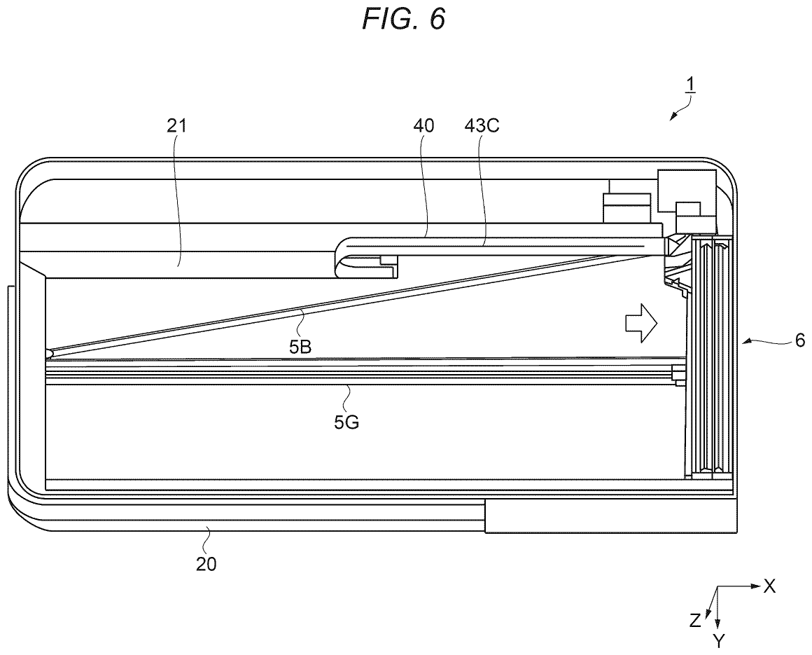

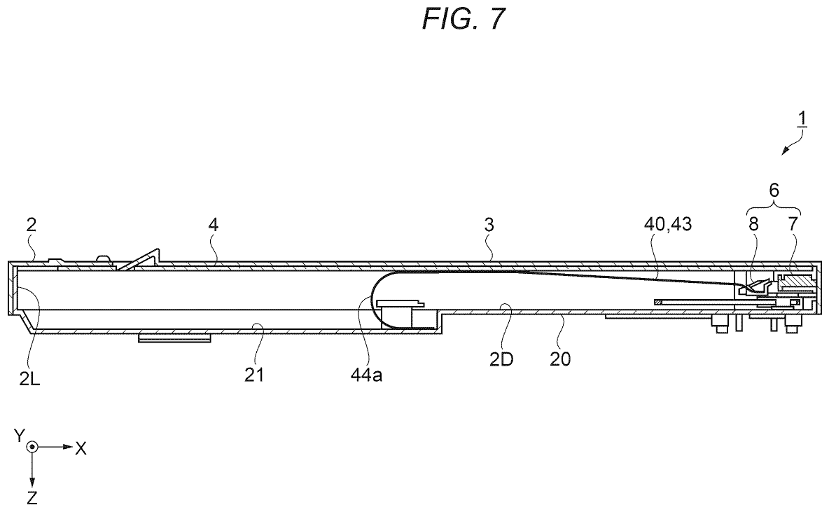

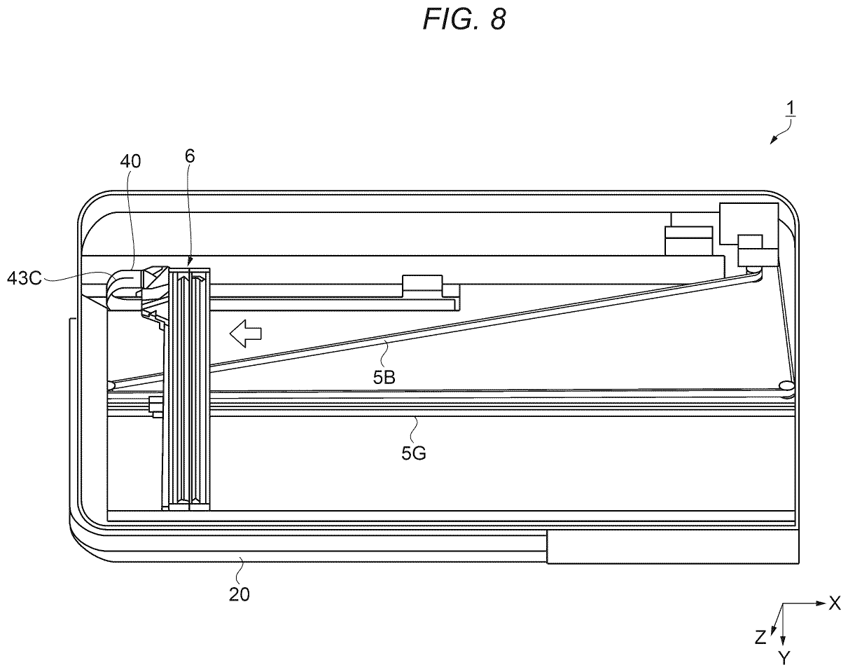

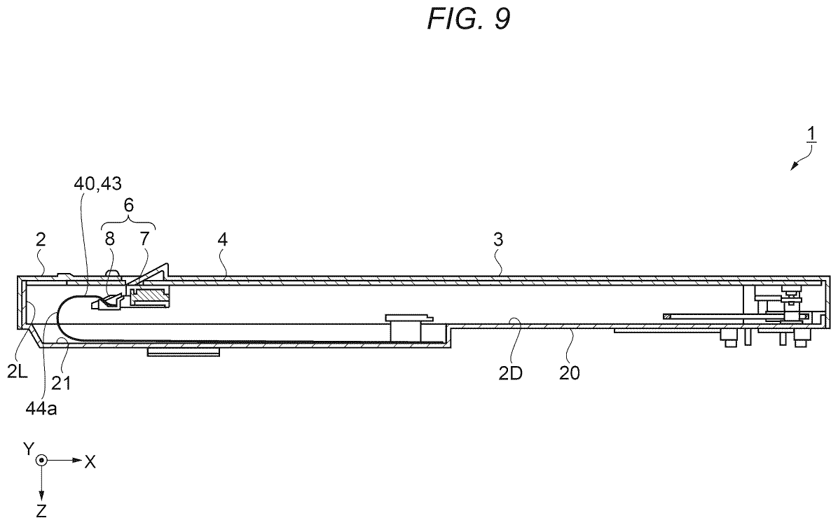

The length of the cable 40 is a length such that the image reading unit 6 can move from the end in the −X direction (see FIGS. 8 and 9) to the end in the +X direction (see FIGS. 6 and 7) of the movable range. The length of the cable 40 is set to be such a length that the bulge of the fourth wiring part 44 in the −X direction does not come into contact with the inner side surface 2L when the image reading unit 6 is located at the end in the −X direction of the movable range.

In this way, since the fold angle θ is an obtuse angle, even when the image reading unit 6 moves forward and backward in the scanning direction, the mountain 43C can repeat becoming flat at the curved portion 44a and restoring the mountain form at a part other than the curved portion 44a. That is, the fold region C can be prevented from being adversely affected by the movement of the image reading unit 6 in the scanning direction.

Also, since the cable 40 is curved along a plane intersecting the document table 4, in other words, is curved in the vertical direction, there is a risk that the cable 40 facing the document table 4 may rub against the document table 4.

Even when the cable 40 comes into contact with the document table 4, the cable 40 has the fold region C where the mountain 43C is provided and therefore only the top part 43Ca of the mountain 43C comes into contact with the document table 4. Therefore, the frictional force of the part in contact with the cable 40 can be suppressed and therefore the occurrence of entangling of the cable 40 and the occurrence of a reading failure of the image reading unit 6 due to the cable 40 not moving smoothly as in the case of a large frictional force can be suppressed.

Also, since the fold region C is provided only at a part facing the document table 4, of the cable 40, that is, only a part of the region is formed as the mountain 43C, friction can be more efficiently suppressed. For example, the fold region C may be provided in a region of the cable 40 that can be the second wiring part 42 and the third wiring part 43 by the movement of the image reading unit 6, and the fold region C may not be provided at the first wiring part 41 and the sixth wiring part 46.

As illustrated in FIG. 12A, in the third wiring part 43 of the cable 40, the core wire 50 is not provided at a center part F in the width direction, that is, in the Y direction. In FIG. 12A, the core wire 50 is schematically illustrated as exposed, but the core wire 50 is preferably covered with an insulating film or the like. The center part F is, for example, a region corresponding to four core wires 50. That is, the core wire 50 is not arranged at the part of the mountain 43C formed in the cable 40. In other words, in the fold region C in the cable 40, the image reading unit 6 and the control unit 15 are not electrically coupled.

In this way, since the fold region C is a region that is not used as a wiring, the occurrence of defects such as breakage of the core wire 50 or a short circuit of the core wire 50 can be suppressed even when the fold region C is folded into the mountain 43C.

As illustrated in FIG. 11, the fifth wiring part 45 is a part extending in the +X direction along the support part 21. At the fifth wiring part 45, the cable 40 is supported by the support part 21. The fifth wiring part 45 is a part whose length changes according to the position of the image reading unit 6 in the X-axis direction. For example, in the X-axis direction, the length of the fifth wiring part 45 when the image reading unit 6 is located on the +X direction side of the center of the movable range is shorter than the length of the fifth wiring part 45 when the image reading unit 6 is located at the center of the movable range.

The sixth wiring part 46 is a part having the terminal part 40b as an end. The sixth wiring part 46 includes a wiring 46a folded back from the fifth wiring part 45, a wiring 46b extending in the −Y direction from the wiring 46a, and a wiring 46c extending in the −Z direction from the wiring 46b. The cable 40 extends to the inside of the document table opening/closing part 10 via the external space of the housing 2, and the terminal part 40b is coupled to the connector 16 (see FIGS. 3 and 4) provided in the control unit 15.

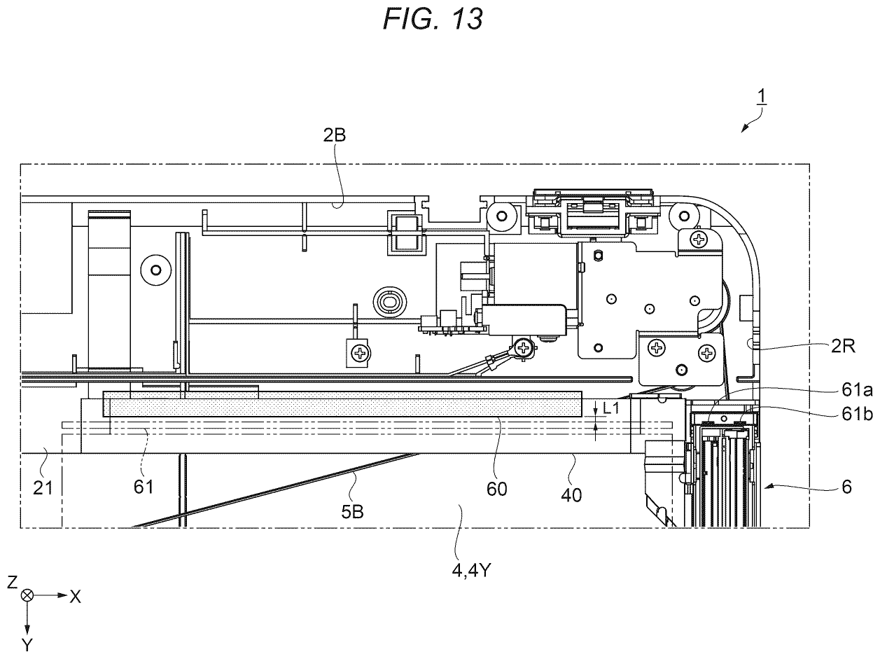

Also, in order to suppress the frictional force between the cable 40 and the part in contact with the cable 40, a low-friction member 60 may be attached to the reading surface 4Y of the document table 4, as illustrated in FIG. 13. However, the image reading unit 6 in the present embodiment is provided with the abutment portions 61a and 61b that detect the distance between the reading surface 4Y and the image reading unit 6. The abutment portions 61a and 61b come into contact with the abutment portion contact region 61 of the reading surface 4Y when the image reading unit 6 moves in the X direction. Also, in the present embodiment, the scanner 1 is miniaturized by arranged the region where the abutment portions 61a and 61b come into contact with each other and the region facing the cable 40 so as to overlap each other when viewed in the Z-axis direction. Since it is not preferable to attach the low-friction member 60 to the abutment portion contact region 61, the reason for which will be described later, the position where the low-friction member 60 is attached is limited.

As shown in FIG. 13, a distance L1 between the low-friction member 60 and the abutment portion contact region 61 is, for example, about 2 mm. When the low-friction member 60 is disposed in a wide range so as to overlap the width of the cable 40 in the Y direction in order to suppress the frictional force by the low-friction member 60 without providing the fold region C in the cable 40, the abutment portions 61a and 61b and the low-friction member 60 come into contact with each other, which causes a problem. In other words, when the cable 40 is disposed so that the entire cable 40 in the Y direction overlaps the low-friction member 60 in order to suppress the frictional force by the low-friction member 60 without providing the fold region C in the cable 40, there is a risk of an increase in the size of the scanner 1 in the Y direction. Therefore, it is not preferable to suppress the frictional force by attaching the low-friction member 60 to the reading surface 4Y.

However, since the cable 40 in the present embodiment has the fold region C where the mountain 43C is provided, only the top part 43Ca of the mountain 43C comes into contact with the document table 4. Therefore, the frictional force of the part in contact with the cable 40 can be suppressed without attaching the low-friction member 60. The fold region C may be provided at a position shifted from the abutment portion contact region 61, and the low-friction member 60 may be provided at a part of the document table 4 with which the top part 43Ca of the mountain 43C comes into contact. With such a configuration, the frictional force can be suppressed more effectively while the scanner 1 is miniaturized by disposing a part of the cable 40 to overlap the abutment portion contact region 61.

As described above, the scanner 1 according to the present embodiment includes: the image reading unit 6 that moves in the scanning direction and thus reads a document; the control unit 15 that controls the image reading unit 6; and the cable 40 that electrically couples the image reading unit 6 and the control unit 15 to each other, and the cable 40 includes the curved portion 44a and is folded so that the folded ridge 43C faces outward at the curved portion 44a, in the fold region C folded along the longitudinal direction, and the image reading unit 6 and the control unit 15 are not electrically coupled in the fold region C.

Also, the cable 40 according to the present embodiment is a flexible flat cable electrically coupling the image reading unit 6 that moves in the scanning direction and thus reads a document and the control unit 15 that controls the image reading unit 6, and includes the curved portion 44a and is folded so that the folded ridge 43C faces outward at the curved portion 44a, in the fold region C along the longitudinal direction, and the image reading unit 6 and the control unit 15 are not electrically coupled in the fold region C.

Also, the method for manufacturing the cable 40 according to the present embodiment is a method for manufacturing the cable 40 electrically coupling the image reading unit 6 that moves in the scanning direction and thus reads a document and the control unit 15 that controls the image reading unit 6, and the method includes: folding the cable 40 so that the folded ridge 43C faces outward at the curved portion 44a, in the fold region C along the longitudinal direction; and causing the image reading unit 6 and the control unit 15 not to be electrically coupled in the fold region C.

Also, the method for manufacturing the scanner 1 according to the present embodiment is a method for manufacturing scanner 1 including the image reading unit 6 that moves in the scanning direction and thus reads a document, the control unit 15 that controls the image reading unit 6, and the cable 40 that electrically couples the image reading unit 6 and the control unit 15 to each other, and the method includes: folding the cable 40 so that the folded ridge faces outward at the curved portion 44a, in the fold region C along the longitudinal direction of the cable 40; causing the image reading unit 6 and the control unit 15 not to be electrically coupled in the fold region C; and coupling the cable 40 to the image reading unit 6 and the control unit 15.

With these configurations, the fold region C in the cable 40 is a region where the image reading unit 6 and the control unit 15 are not electrically coupled to each other, in other words, a region that is not used as a wiring, and therefore the occurrence of problems such as breakage of the core wire 50 or a short circuit of the core wire 50 can be suppressed even when the cable 40 is folded into the mountain 43C. Also, even when the cable 40 folded into the mountain 43C along the longitudinal direction comes into contact with, for example, the document table 4, only the top part 43Ca of the linear mountain 43C comes into contact with the document table 4 and therefore the frictional force can be suppressed and the occurrence of the entangling of the cable 40 or the occurrence of the reading failure due to the operation failure of the image reading unit 6 can be suppressed.

Also, in the scanner 1 according to the present embodiment, a wiring for electrically coupling the image reading unit 6 and the control unit 15 may be not provided in the fold region C in the cable 40. With this configuration, since no wiring is provided, in other words, since the core wire 50 serving as a wiring is not disposed in the fold region C, the occurrence of problems such as breakage of the core wire 50 or a short circuit of the core wire 50 can be suppressed. In addition, since the core wire 50 is not provided, the required cost can be suppressed.

In the scanner 1 according to the present embodiment, the fold angle θ of the cable 40 may be an obtuse angle. With this configuration, since the fold angle θ is an obtuse angle, the mountain 43C can be repeatedly made flat and restore the form of the mountain 43C even when the image reading unit 6 moves forward and backward in the scanning direction. That is, the resistance with the part in contact with the cable 40 can be suppressed and the adverse effect on the fold region C can be suppressed.

Also, the scanner 1 according to the present embodiment may include the document table 4 on which the document read by the image reading unit 6 is placed, and the cable 40 may be curved along a plane intersecting the document table 4. With this configuration, since the cable 40 is curved along the plane intersecting the document table 4, in other words, is curved in the vertical direction, there is a risk that the cable 40 facing the document table 4 may rub against the document table 4. However, since the cable 40 is folded into the mountain 43C, the part in contact with the document table 4 can be only the top part 43Ca of the mountain 43C and the frictional force can be suppressed. Therefore, the entangling of the cable 40 and the occurrence of the reading failure due to the operation failure of the image reading unit 6 can be suppressed.

Also, in the scanner 1 according to the present embodiment, the folded ridge 43C of the cable 40 may face the document table 4. With this configuration, since the mountain 43C and the document table 4 face each other, there is a risk that the document table 4 and the mountain 43C of the cable 40 may rub against each other. However, since the cable 40 is folded into the mountain 43C, the part in contact with the document table 4 can be only the top part 43Ca of the mountain 43C and the frictional force can be suppressed.

In the scanner 1 according to the present embodiment, the cable 40 may be provided with the fold region C at a part facing the document table 4 due to the movement of the image reading unit 6. With this configuration, since the fold region C is provided only at the part of the cable 40 facing the document table 4, that is, only a part of the region is defined as the mountain 43C, the friction can be suppressed more efficiently.

Also, in the scanner 1 according to the present embodiment, the image reading unit 6 may include the abutment portions 61a and 61b that come into contact with the document table 4, and at the document table 4, the abutment portion contact region 61 with which the abutment portions 61a and 61b come into contact and the region faced by the cable 40 may overlap each other. With this configuration, since the abutment portions 61a and 61b come into contact with the document table 4, for example, the distance between the position detection unit and the document table 4 can be made appropriate. Also, since the abutment portion contact region 61 which the abutment portions 61a and 61b come into contact with and the region faced by the cable 40 overlap each other, the scanner 1 can be miniaturized. Also, in the case where a measure such as attaching the low-friction member 60 to the region of the document table 4 facing the cable 40 is taken in order to suppress the friction between the cable 40 and the document table 4, when the abutment portions 61a and 61b come into contact therewith, there is a risk that the distance between the position detection unit and the document table 4 may become inappropriate or the positional relationship may become inappropriate during repeated sliding. However, since the fold region C is provided, the low-friction member 60 need not be attached to the document table 4, and the occurrence of defects such as the entangling of the cable 40 can be suppressed.

Also, the recording device 100 according to the present embodiment includes the scanner 1 described above and the recording unit 101 that records an image read by the scanner 1 on a medium. This configuration enables the provision of the recording device 100 such as a multifunction peripheral in which the occurrence of a problem in the cable 40 can be suppressed.

A modification example of the above embodiment will be described below.

The configuration in which the core wire 50 is not arranged at the center part F of the cable 40, that is, in the fold region C, as described above, is not limiting and the core wire 50 may be arranged in the fold region C. In this case, for example, the four core wires 50 arranged in the fold region C are configured not to transmit a control signal.

In this way, in the scanner 1 according to the modification example, the cable 40 may include a plurality of wirings that electrically couple the image reading unit 6 and the control unit 15, and the wiring located in the fold region C may not transmit a control signal. With this configuration, since the wiring formed of the core wire 50 disposed in the fold region C is not used, an electrical influence can be suppressed even when the core wire 50 is broken in the fold region C. Also, since the core wires 50 are arranged in all the regions, the cable 40 can be used in a versatile manner.

When the core wire 50 is disposed in the fold region C as in the above modification example, the wiring located in the fold region C may be grounded. With this configuration, since the core wire 50 disposed in the fold region C is grounded, the unused core wire 50 can be prevented from electrically floating, in other words, the generation of a potential difference can be suppressed. Therefore, the influence of noise or the like can be suppressed. Also, the core wires may be coupled in the same manner as a power supply line of approximately 3 to 5 V as long as the core wires are not affected by noise.

The number of core wires 50 in the fold region C is not limited to four. The position of the mountain 43C is not limited to the center part F of the cable 40.

The curved portion 44a of the cable 40 is not limited to being curved along the plane intersecting the document table 4, that is, being curved along the vertical direction, as described above, and may be curved along a horizontal plane. When the cable 40 is curved along the horizontal plane, the member on the side of the cable 40 comes into contact with the cable 40. Even in this case, only the member on the side and the mountain 43C of the cable 40 come into contact with each other and therefore the friction between the cable 40 and the member can be suppressed.

As described above, the scanner I is not limited to having the function of the ADF, and the user may set one sheet of a document on the document table 4 and cause the image reading unit 6 to read the document.

What is claimed is:

1. An image reading device comprising:
an image reading unit that moves in a scanning direction and thus reads a document;
a control unit that controls the image reading unit; and
a flexible flat cable that electrically couples the image reading unit and the control unit to each other,
the flexible flat cable including a curved portion and being folded so that a folded ridge faces outward at the curved portion, in a fold region folded along a longitudinal direction,
the image reading unit and the control unit not being electrically coupled in the fold region.

2. The image reading device according to claim 1, wherein
the fold region in the flexible flat cable is not provided with a wiring that electrically couples the image reading unit and the control unit.

3. The image reading device according to claim 1, wherein
the flexible flat cable includes a plurality of wirings that electrically couple the image reading unit and the control unit, and
the wiring located in the fold region does not transmit a control signal.

4. The image reading device according to claim 3, wherein the wiring located in the fold region is grounded.

5. The image reading device according to claim 1, wherein
a fold angle of the flexible flat cable is an obtuse angle.

6. The image reading device according to claim 1, further comprising:
a document table on which the document to be read by the image reading unit is placed, wherein
the flexible flat cable is curved along a plane intersecting the document table.

7. The image reading device according to claim 6, wherein
the folded ridge of the flexible flat cable faces the document table.

8. The image reading device according to claim 7, wherein
the flexible flat cable is provided with the fold region at a part facing the document table due to a movement of the image reading unit.

9. The image reading device according to claim 6, wherein
the image reading unit includes an abutment portion that comes into contact with the document table, and
at the document table, a region which the abutment portion comes into contact with and a region faced by the flexible flat cable overlap each other.

10. A recording device comprising:
the image reading device according to claim 1; and
a recording unit that records an image read by the image reading device on a medium.

11. A flexible flat cable electrically coupling an image reading unit that moves in a scanning direction and thus reads a document and a control unit that controls the image reading unit,
the flexible flat cable including a curved portion,
the flexible flat cable being folded so that a folded ridge faces outward at the curved portion, in a fold region along a longitudinal direction,
the image reading unit and the control unit not being electrically coupled in the fold region.

12. A method for manufacturing a flexible flat cable electrically coupling an image reading unit that moves in a scanning direction and thus reads a document and a control unit that controls the image reading unit, the method comprising:
folding the flexible flat cable so that a folded ridge faces outward at a curved portion, in a fold region along a longitudinal direction; and
causing the image reading unit and the control unit not to be electrically coupled in the fold region.

13. A method for manufacturing an image reading device, the image reading device comprising an image reading unit that moves in a scanning direction and thus reads a document, a control unit that controls the image reading unit, and a flexible flat cable that electrically couples the image reading unit and the control unit to each other, the method comprising:
the method for manufacturing flexible flat cable according to claim 12; and
coupling the flexible flat cable to the image reading unit and the control unit.
